(19) United States
(12) Patent Application Publication
(10) Pub. No.: US 2020/0340707 A1
(43) Pub. Date: Oct. 29, 2020

(54) CHEMICAL ROD FOR HVAC FLUID CONDITIONING SYSTEM AND METHOD OF MANUFACTURE

(71) Applicant: AC Freeflow, Fort Lauderdale, FL (US)

(72) Inventors: Richmond Italia, Dorval (CA); Louis Spicer, Sewell, NJ (US)

(73) Assignee: AC Freeflow, Fort Lauderdale, FL (US)

(21) Appl. No.: 16/924,436

(22) Filed: Jul. 9, 2020

Related U.S. Application Data
(63) Continuation-in-part of application No. 16/117,895, filed on Aug. 30, 2018.
(60) Provisional application No. 62/873,359, filed on Jul. 12, 2019.
(60) Provisional application No. 62/553,253, filed on Sep. 1, 2017.

(51) Int. Cl. F24F 13/22; B23P 19/02

(52) U.S. Cl. CPC F24F 13/22; F24F 2013/228; B23P 19/02

(57) ABSTRACT

An HVAC fluid conditioning system may utilize chlorine (or other chemical) rods to treat an HVAC fluid. The chemical rod preferably has a length longer than a width (or diameter) of the rod to prevent the rod from tipping within a receptacle of the HVAC fluid conditioning system. The chemical rod may have a substantially circular cross-section wherein the width is equal to the diameter of the cross-section. The rod may have a length longer than about three inches and a width or diameter of about one inch or less. The circular rod may be formed by placing a rod with a substantially rectangular (e.g., square) cross-section into a press and pressing the rectangular rod between two molds, each having a semicircular opening, to form a rod having a substantially circular cross-section. A releasing agent may be applied to the rod or mold to facilitate easy release.

### RELATED APPLICATIONS

### Incorporation by Reference and Priority Claims

This application is a non-provisional of, and claims priority from, U.S. Provisional Patent Application Ser. No. 62/873,359, filed Jul. 12, 2019. This application is also a continuation-in-part of, and claims priority from, U.S. patent application Ser. No. 16/117,895, filed Aug. 30, 2018, which is a non-provisional of, and claims priority from, U.S. Provisional Patent App. Ser. No. 62/553,253, filed Sep. 1, 2017. The contents of each of these applications are incorporated herein by reference in their entirety.

### BACKGROUND OF THE INVENTION

### Field of the Invention

This invention relates generally to heating, ventilation, and air conditioning (HVAC) systems, and particularly to those in which fluids might collect as condensation as a result of the cooling process. This invention particularly relates to chemicals that may be used to clean, disinfect, and/or sanitize HVAC fluids and to methods of manufacturing those chemicals in a form to be used in an HVAC fluid conditioning system.

### SUMMARY OF THE INVENTION

According to one aspect of our invention, a conditioning unit or system is installed in an HVAC unit to dispense an appropriate amount of chlorine or other conditioning chemical into the fluid stream to condition the fluid to prevent growth of harmful pollutants.

More particularly, a chlorine or other chemical dispenser may be installed in an HVAC condensation line, pan, or pump. The dispenser may, for instance, dispense a chlorine (or other chemical) tablet, rod, or liquid into contact with the AC condensation water to eliminate algae and/or other harmful pollutants. By eliminating the growth of harmful contaminants, the invention can provide a robust, reliable, and cost-effective solution for preventing clogged pipes and water back-ups due to contaminant growth in the HVAC system. Other water treatment or purification processes or systems could also be used, such as an ultra-violet (UV) light treatment process, for example.

According to one embodiment, a chlorine tablet or rod dispenser can be installed in the AC condensation line of an HVAC system. Tablets or rod(s) may be inserted into a receptacle of the dispenser and can feed into the condensation line, pan, or pump. The receptacle may have an inside diameter of less than 1 inch. Condensation water running through the condensation line can pass by the tablet or rod and be conditioned with chlorine or other chemical agents or treatment processes to kill contaminants and prevent the further growth of algae and/or other harmful contaminants. Various possible embodiments of such a system are illustrated in the attached drawings and other such embodiments will be readily apparent to those of ordinary skill in the art based on this disclosure.

According to one embodiment of the present inventive concepts, the chemical agent can be provided in the form of a rod that may be readily inserted into and dispensed from the HVAC conditioning unit. The rod preferably has a length that is longer than its width to keep it properly aligned in the conditioning unit. Among other benefits, this configuration can help keep the rod from tipping over or laying sideways in the receptacle (or dispenser channel). In one such embodiment, the diameter of the rod may be less than about 1 inch, and the length of the rod may be approximately about 3 inches.

In one embodiment, the chemical agent is chlorine mixed with a binding agent such as calcium, borax, animal fat, magnesium stearate, or any other binding agent(s). The binding agent acts to hold the chlorine together in the form of a rod. The rod may be formed by pressing the chlorine mixed with the binding agent through a special die. A releasing agent, such as magnesium stearate (which can also act as a binding agent) or other releasing agent, may be used to help the rods eject from the press properly without sticking to the tooling.

Of course, other types of fungicides may be used instead of, or in conjunction with, chlorine. Salt or a salt compound, bromine, or other chemicals, could also be used as the chemical agent in addition to, or instead of, chlorine.

It should be noted that the HVAC fluid conditioning system could be used in conjunction with a P or S trap plumbing system, for example, to keep chlorine gas or other noxious fumes from entering into the structure being air conditioned. The trap system can, for instance, be installed upstream of the dispenser or be formed as part of the chemical treatment (conditioning) system to provide water to trap the chlorine or other fumes rather than permit them to enter the ambient air. Such a system will preferably prevent the HVAC system from sucking up the chlorine or other harmful gases and spreading them to the structure being air conditioned.

Numerous other potential embodiments are also contemplated as being within the scope of the present invention and will be readily apparent to those of skill in the art based on the information provided. For instance, other delivery systems are also contemplated and may replace the tablet or rod dispenser. A chlorine or other chemical dripping system, for example, could be used to supply the treatment chemicals to the liquid. Alternatively, a UV light treatment system could be provided to treat the HVAC fluid with UV light to remove the pollutants.

A method for making a chemical cleaning rod is also contemplated. According to one method, a cleaning agent, such as chlorine (or other fungicide) is mixed with an appropriate amount of binding agent to form chemical bars. One or more chemical bars are then placed into a press having press molds. A releasing agent (such as magnesium stearate) may be provided to each of the bars or the press molds in order to cause the chemical rods to readily release from the press molds after forming. The press molds may, for instance, include opposing half molds, each having an opening with a semi-circular cross-section. Opposing molds are pressed together with one of the bars placed therebetween to produce a chemical rod. The chemical rod may then be cut into smaller desired lengths to provide chemical cleaning rods of the desired dimensions to be used in the HVAC conditioning unit.

Various further aspects, embodiments, and configurations of this invention are possible without departing from the principles disclosed herein. This invention is therefore not limited to any of the particular aspects, embodiments, or configurations described herein.

### BRIEF DESCRIPTION OF DRAWINGS

The foregoing and additional objects, features, and advantages of the present invention will become more readily apparent from the following detailed description of preferred embodiments, made with reference to the accompanying drawings, in which:

FIG. 1 is a somewhat schematic cross-sectional side view of an HVAC fluid conditioning system according to one embodiment of the inventive concepts, including an inlet pipe connection, an outlet pipe connection, and a chlorine tablet or rod dispenser with a chlorine tablet or rod receptacle (housing chlorine tablets therein) arranged between the inlet and outlet pipe connections;

FIG. 2 is a somewhat schematic perspective view of the chlorine tablet or rod container (or receptacle) of the chlorine tablet or rod dispenser of FIG. 1;

FIG. 3 is a somewhat schematic side view of the HVAC fluid conditioning system of FIG. 1, showing the conditioning system in partially transparent view and the chlorine tablet or rod receptacle in side view, and with arrows illustrating the flow of liquid through the HVAC fluid conditioning system;

FIG. 4 is a somewhat schematic exploded perspective view of an HVAC fluid conditioning system according to another embodiment of the present inventive concepts;

FIG. 5 is a somewhat schematic perspective view of the assembled HVAC fluid conditioning system of FIG. 4;

FIG. 6 is a somewhat schematic side view of the assembled HVAC fluid conditioning system of FIG. 5;

FIG. 7 is a somewhat schematic front view of the assembled HVAC fluid conditioning system of FIG. 5;

FIG. 8 is a somewhat schematic cross-sectional side view of the assembled HVAC fluid conditioning system of FIG. 5, taken along line A-A of FIG. 7;

FIG. 8A is a reproduction of FIG. 8, but further includes arrows illustrating a flow of liquid through the HVAC fluid conditioning system;

FIG. 9 is a somewhat schematic perspective view of a chemical rod according to principles of the present inventive concepts;

FIG. 9A is a somewhat schematic side view of the chemical rod of FIG. 9;

FIG. 9B is a somewhat schematic front view of the chemical rod of FIG. 9;

FIG. 10 is a somewhat schematic illustration of a press for forming a chemical rod according to additional features of the present inventive concepts;

FIG. 11 is a somewhat schematic illustration of tools used in the press of FIG. 10 to form the chemical rod of FIG. 9; and

FIG. 12 is a schematic flow diagram illustrating various steps in a method of forming a chemical rod according to still further features of the present inventive concepts.

### DETAILED DESCRIPTION OF ILLUSTRATIVE EMBODIMENTS

Various features, benefits, and configurations incorporating principles of the inventive concepts in illustrative embodiments are shown in the accompanying drawings. Additional features, benefits, and configurations will be readily apparent to those of ordinary skill in the art based on this disclosure, and all such features, benefits, and configurations are considered within the scope of the present invention. Various embodiments will now be described in further detail in connection with the accompanying drawings.

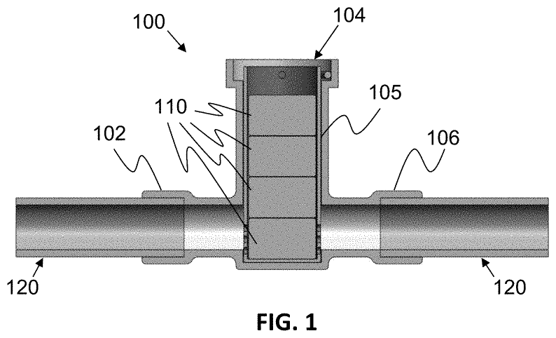

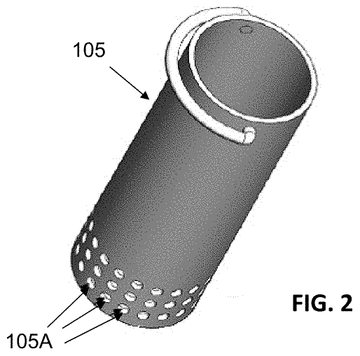

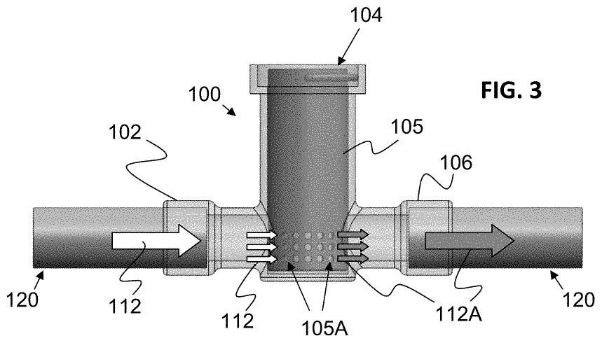

FIG. 1 is a somewhat schematic cross-sectional side view of an HVAC fluid conditioning system 100 according to one embodiment of the inventive concepts, including an inlet pipe connection 102, an outlet pipe connection 106, and a chlorine tablet dispenser 104 with a chlorine tablet (or rod) receptacle 105 housing chlorine tablets 110 (or a chlorine rod) therein. The chlorine dispenser 104 is preferably arranged between the inlet and outlet pipe connections 102, 106, respectively. FIG. 2 is a somewhat schematic perspective view of the chlorine tablet or rod container or receptacle 105 of the chlorine tablet or rod dispenser 104 of FIG. 1. And FIG. 3 is a somewhat schematic side view of the HVAC fluid conditioning system 100 of FIG. 1, showing the conditioning system 100 in transparent view and the chlorine tablet container 105 in side view. Arrows 112, 112A are further provided to illustrate the flow of liquid through the HVAC fluid conditioning system 100.

Referring to FIGS. 1 through 3, according to an embodiment of the inventive concepts, a fluid conditioning unit 100 is installed in an HVAC unit (not shown) to dispense an appropriate amount of chlorine or other conditioning chemical into the fluid stream (represented by arrows 112) to condition the fluid 112 to kill and prevent growth of harmful pollutants.

More particularly, a fluid conditioning system 100 such as a chlorine or other chemical dispenser (or UV light treatment system) may be installed in an HVAC condensation line 120. The fluid conditioning system 100 may, for instance dispense a chlorine tablet 110 or other chemical tablet or rod into contact with the AC condensation water (or other conditioning fluid) 112 to eliminate algae and/or other harmful pollutants. By eliminating growth of harmful contaminants, the invention can provide a robust, reliable, and cost-effective solution for preventing clogged pipes and water back-ups due to contaminant growth in the HVAC system (not shown).

According to one embodiment, an HVAC fluid conditioning system 100 can be a chemical dispenser installed in the AC condensation line 120 of an HVAC system (not shown). Tablets 110 may be inserted into a container/receptacle 105 of the dispenser 100 and can feed into the condensation line 120. Condensation water 112 running through the condensation line 120 can pass by the tablet 110 (through holes or other openings 105A arranged in the container 105) and be conditioned with chlorine (or other chemicals or fungicides or UV light) to kill and prevent the growth of algae and/or other harmful contaminants. The conditioned condensation water 112A is then delivered back to the condensation line 120.

It should be noted that this system could be used in conjunction with a P or S trap plumbing system, for example, to keep chlorine fumes or other harmful gases from entering into the structure being air conditioned. The trap system can, for instance, be installed upstream of the dispenser or be included as part of the dispenser to provide water to trap the chlorine fumes rather than permit them to enter the ambient air. Such a system will preferably prevent the HVAC system from sucking up the chlorine gas (or other harmful gases) and spreading it to the structure being conditioned.

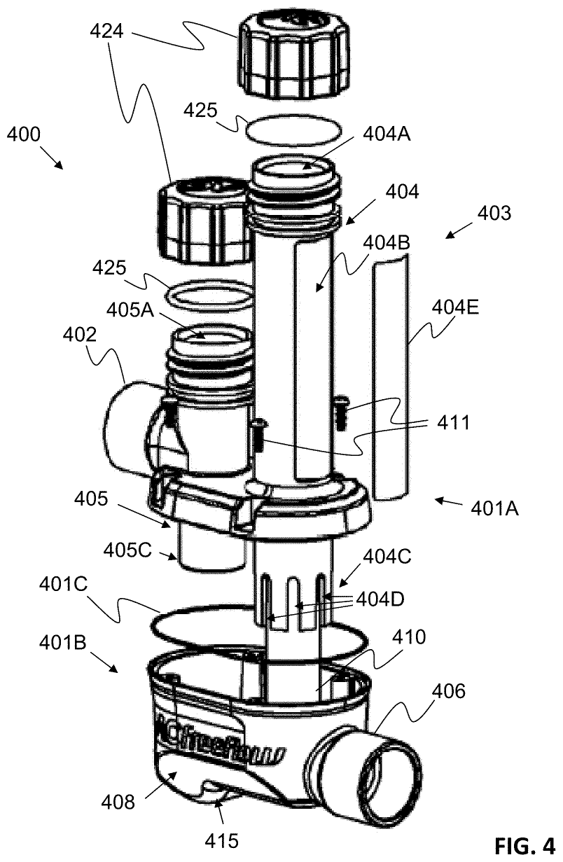

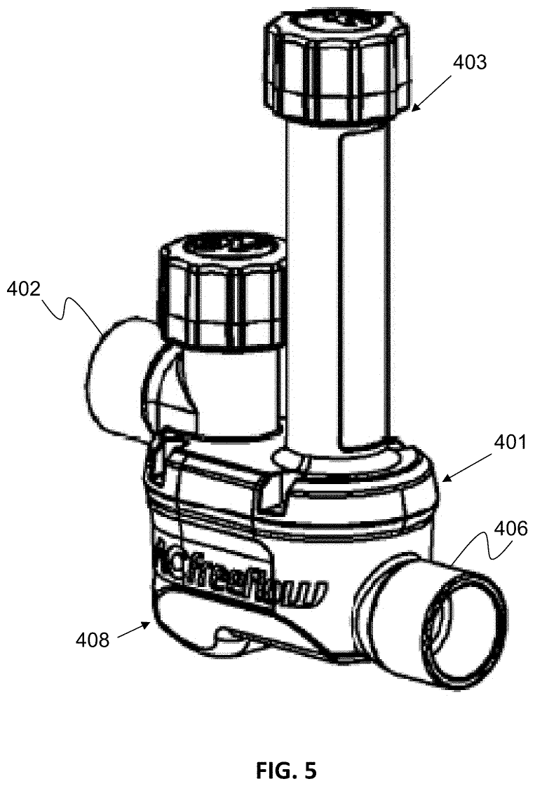

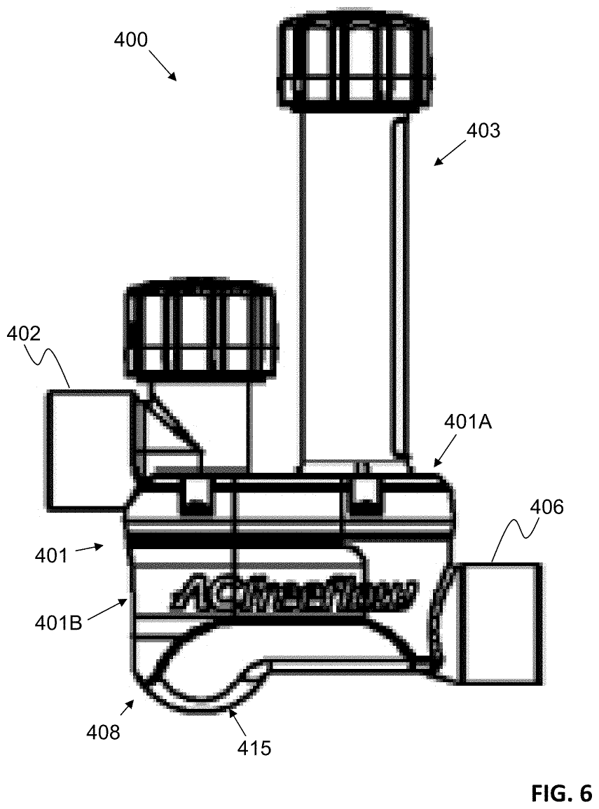

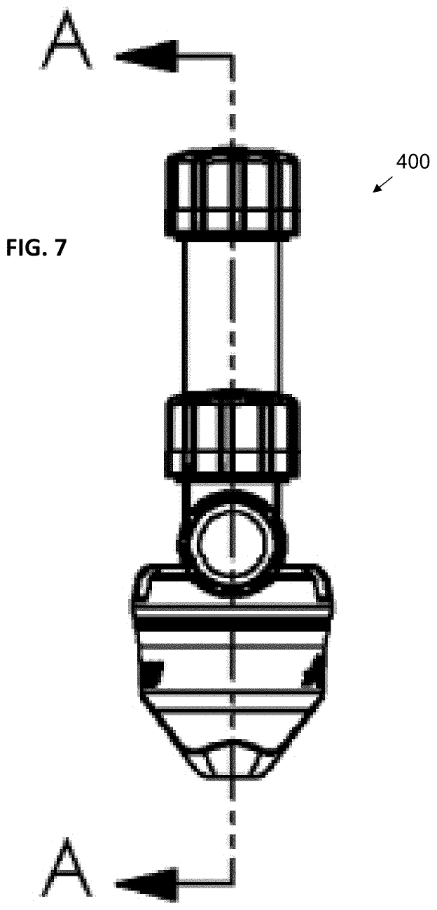

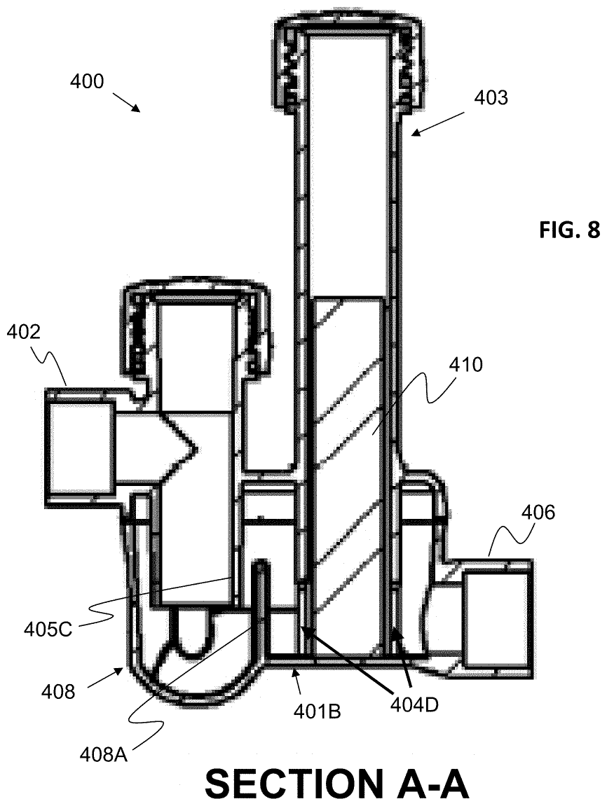

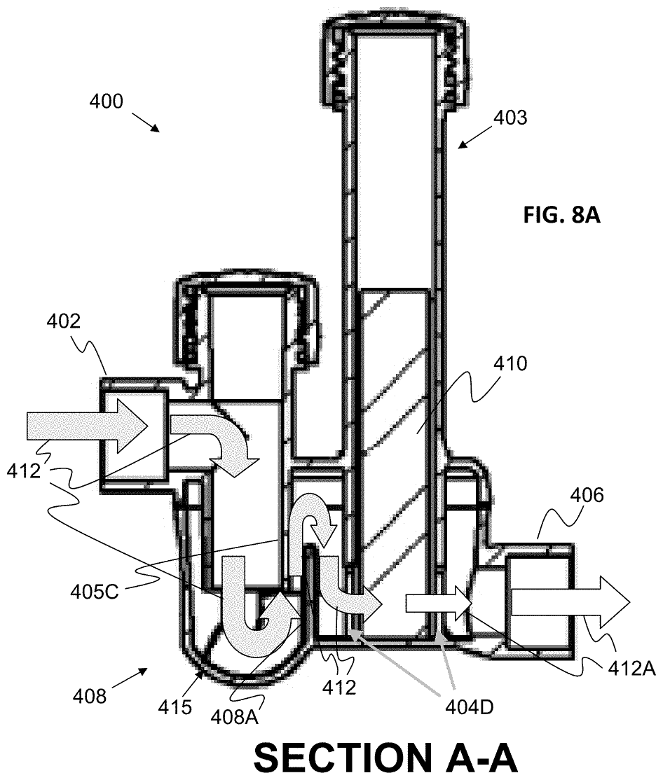

Of course, alternative embodiments are also possible. FIG. 4 is a somewhat schematic exploded perspective view of an HVAC fluid conditioning system 400 according to another embodiment of the present inventive concepts. FIG. 5 is a somewhat schematic perspective view of the assembled HVAC fluid conditioning system 400 of FIG. 4. FIG. 6 is a somewhat schematic side view of the assembled HVAC fluid conditioning system 400 of FIG. 5. FIG. 7 is a somewhat schematic front view of the assembled HVAC fluid conditioning system 400 of FIG. 5. FIG. 8 is a somewhat schematic cross-sectional side view of the assembled HVAC fluid conditioning system 400 of FIG. 5, taken along line A-A of FIG. 7. And FIG. 8A is a reproduction of FIG. 8, further including arrows 412, 412A to illustrate a flow of liquid through the HVAC fluid conditioning system 400.

Referring to FIGS. 4-8A, an HVAC fluid conditioning system 400 according to this embodiment includes an inlet pipe connector 402, an outlet pipe connector 406, and a tablet or rod dispensing unit 403. In addition, however, the HVAC conditioning system 400 also preferably provides an S or P-type trap system 408 for trapping potentially hazardous fumes within the dispenser unit 400 with the condensation fluid.

The HVAC fluid conditioning system 400 can include a housing 401 formed by connecting two sections (i.e., a top section 401A and a bottom section 401B) together, using screws 411 or some other connection mechanism. A seal 401C can be included between the top and bottom sections 401A, 401B, respectively, to prevent fluid leaks. The top section 401A can, for example, provide the tablet or rod dispenser unit 403, and the bottom section 401B can provide the S or P-type trap system 408.

The tablet or rod dispenser unit 403 can include a pipe or tube 404 that provides a receptacle with an opening 404B to receive chlorine (or other chemical) tablets or a rod 410 therein. A door or cover 404E can be provided to cover the opening 404B after the tablets or rod 410 has been inserted. The bottom end 404C of the tube 404 can include slots, holes, or other openings 404D to permit the flow of fluid 412 therethrough.

In operation, chlorine tablets or a rod 410 inserted into the opening 404B of the tablet dispenser unit 403 may drop to the bottom 404C of the tube 404. Water or other HVAC liquid 412 enters the conditioning system through the inlet connector 402. The HVAC liquid 412 passes through the trap 408 and then through the openings 404D in the bottom 404C of the tube 404 and contacts the bottom-most tablet or rod 410 in the dispenser unit 403. As the HVAC liquid passes by the rod 410 (or tablets), it dissolves the rod 410 and thereby treats the HVAC liquid 412 with chlorine (or other treatment chemicals). The treated HVAC fluid 412A is then delivered back to the HVAC system or outputted from the system through the outlet pipe connector 406.

Another pipe or tube 405 can be arranged near the inlet pipe connection 402 and over the S or P-type trap 408, with a bottom wall 405C thereof forming a part of the trap system. The bottom housing section 401B can provide a rounded portion 415 configured to direct liquid flow 412 around the wall 405C and into the dispenser unit 403. The bottom housing section 401B can also comprise a wall 408A that extends away from the housing bottom 401B to form an additional part of the trap system 408. The S or P-type trap system 408 preferably traps liquid in the bottom housing section 401B to form a liquid seal that keeps unwanted gases from escaping back through the inlet pipe connector 402 and into the HVAC system (not shown).

Depending on where the conditioning system 400 is installed, it could be pressurized from a pump or have water back up, and it is therefore important to have a watertight and airtight system that prevents leakage of fluids and gasses. Threaded caps 424 and seals 425 can therefore be included on the two tubes 404 and 405 to cover and seal openings 404A, 405A in the tops of the tubes to help provide a watertight and airtight system. The removable caps 424 further provide access to the tubes 404 and 405 for maintenance and cleaning and allow de-pressurization of the system 400. The threaded cap 424 over tube 405, for example, can be removed to permit access to, and cleaning of, the P trap 408 (in this embodiment). Additional chemicals could also be added through the top opening 405A in tube 405 to clean the trap 408 if there is ever a buildup of algae or other contaminants.

As explained above, an HVAC fluid conditioning system can prevent harmful pollutants from clogging or otherwise impairing a fluid flow through an HVAC system. A trap system can further ensure that harmful gases do not escape the HVAC fluid conditioning system and enter the structure being air conditioned. In alternative embodiments, a chemical drip system or UV light system could be used to condition the HVAC fluid.

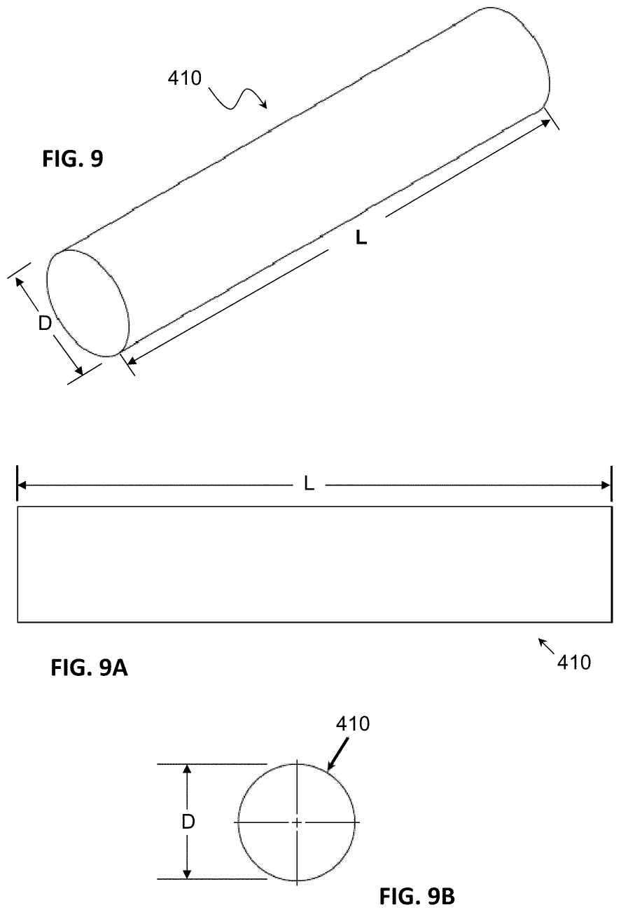

Referring now additionally to FIGS. 9-9B, as further explained above, the chemical cleaning agent can be provided in the form of a rod 410. The chemical rod 410 may include a chemical agent, such as chlorine, bromine, salt, or other fungicide, and a binding agent, such as calcium, borax, animal fat, magnesium stearate, or other binding agent that holds the rod 410 in shape.

According to one embodiment of the present inventive concepts, the chemical agent can be provided in the form of a rod 410 that may be readily inserted into and dispensed from the HVAC conditioning unit. The rod 410 preferably has a length L that is longer than its width (or diameter) D to keep it properly aligned in the conditioning unit 400. This configuration can help keep the rod 410 from tipping over or laying sideways in the receptacle (or dispenser channel) 404 of the conditioning system 400. In one embodiment, the diameter D of the rod may be less than about 1 inch, and the length L of the rod is approximately about 3 to 5 inches.

In one embodiment, the chemical agent is chlorine mixed with a binding agent, such as calcium, borax, magnesium stearate, or animal fat. The binding agent holds the chlorine together in the form of a rod. Of course, other types of fungicides may be used instead of, or in conjunction with, the chlorine. For instance, salt or a salt compound, bromine, or other chemical, could also be used as the chemical agent either alone or mixed with other chemicals.

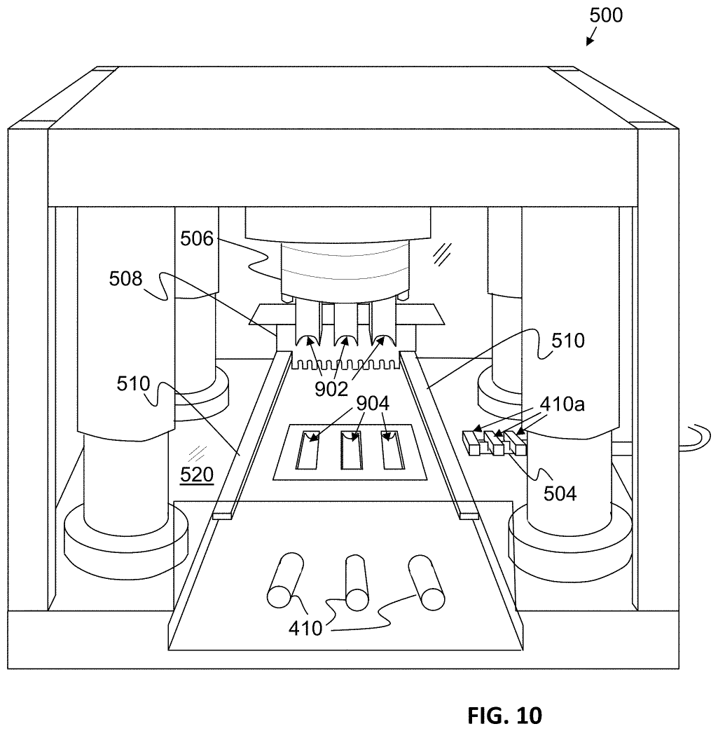

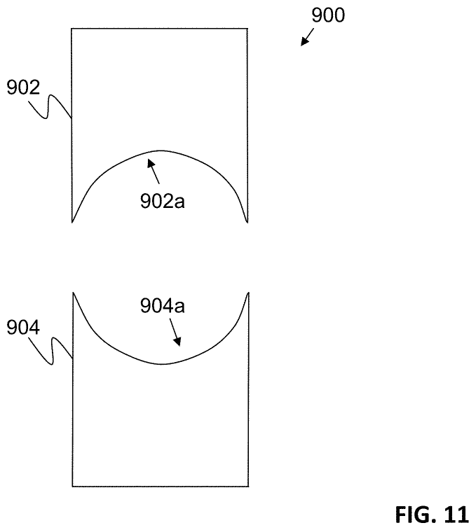

Referring now to FIGS. 10-12, the chemical rod 410 may be formed by pressing the chemical compound (i.e., chlorine mixed with the binding agent) into a special die or mold 900, which may include top and bottom halves 902, 904, respectively. A releasing agent, such as magnesium stearate (which can also act as a binding agent), may be applied to the die or mold 900 and/or rods 410a before pressing to assist in ejecting the rods 410 from the press 500 properly.

More particularly, the chemical compound may be provided to the manufacturing unit 500 in the form of rectangular rods 410a with substantially rectangular (for example, square) cross-sections. The rectangular rods 410a may be placed into the manufacturing unit 500 on top of semi-circular die or bottom molds 904 using a hydraulic and/or robotic arm 504. Three or more rods 410a may be placed into the unit 500 at one time. A releasing agent can be sprayed onto the rods 410a and/or top and bottom molds 902, 904. A press 506 then compresses the rods between the top and bottom molds 902, 904, respectively, each having openings with semi-circular cross-sections, to form a rod 410 having a substantially circular cross-section. A transparent wall (such as glass, plexiglass, or transparent plastic) or other wall or barrier 520 may be provided around the press to help contain the chemical residue from the manufacturing processes. A shuttle 508 may travel forward and back along rails 510, to eject the rods 410 from the unit 500 once they are formed.

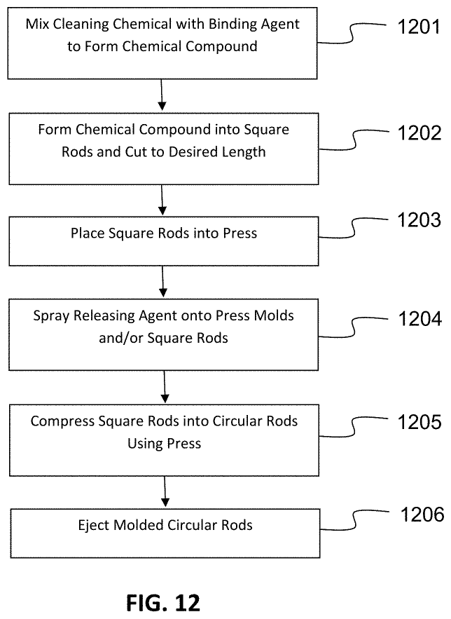

Referring specifically to FIG. 12, a method for making a chemical cleaning rod is contemplated. According to this method, a cleaning agent, such as chlorine (or other fungicide) is mixed with an appropriate amount of binding agent to form a chemical compound in a first step 1201. The mixed ingredients in the chemical compound are formed into chemical rods having a square cross-section using a die and press during a second step 1202. The rod is then cut into desired lengths and then fed to the press, for example, using one or more robotic or hydraulic arms, during a third step 1203. The square rods are placed on the press and covered with a releasing agent such as magnesium stearate in a fourth step 1204. The rods are then compressed using semi-circular top and bottom (or side to side) die or molds to provide substantially circular chemical rods to be used in the HVAC conditioning unit during a fifth step 1205. The chemical cleaning rods are then ejected from the molds in a sixth step 1206.

Having described and illustrated principles of the present invention in various preferred embodiments thereof, it should be apparent that the invention can be modified in arrangement and detail without departing from such principles.

What is claimed is:

1. A chemical cleaning rod for an HVAC fluid conditioning system, said chemical cleaning rod comprising:
a chemical cleaning compound formed into a body comprising a width and a length, wherein the length is longer than the width.

2. The chemical cleaning rod according to claim 1, wherein the chemical cleaning compound comprises a chemical cleaning agent and a binding agent.

3. The chemical cleaning rod according to claim 2, wherein the chemical cleaning agent comprises one or more of chlorine, bromine, and salt.

4. The chemical cleaning rod according to claim 2, wherein the binding agent comprises one or more of calcium, borax, magnesium stearate, and animal fat.

5. The chemical cleaning rod according to claim 4, wherein the chemical cleaning agent comprises chlorine and wherein the binding agent comprises calcium.

6. The chemical cleaning rod according to claim 1, wherein the rod has a substantially circular cross-section and wherein the width is equal to a diameter of the cross-section.

7. The chemical cleaning rod according to claim 1, wherein the length is approximately between about three to about five inches.

8. The chemical cleaning rod according to claim 1, wherein the width is approximately about one inch or less.

9. The chemical cleaning rod according to claim 1, wherein the chemical cleaning compound is formed into the body using a press.

10. The chemical cleaning rod according to claim 9, wherein the body is pressed into a substantially circular cross-section using semi-circular molds.

11. A method of forming a chemical cleaning rod, said method comprising:
mixing a chemical cleaning agent with a binding agent to form a chemical cleaning compound;
forming the chemical cleaning compound into rectangular rods having a substantially rectangular cross-section; and
pressing the rectangular rods into circular rods having a substantially circular cross-section.

12. The method according to claim 11, further comprising:
cutting the rectangular rods to a desired length before pressing the rectangular rods.

13. The method according to claim 11, wherein pressing the rectangular rods into circular rods comprises:
placing the rectangular rods into a press; and
pressing the rectangular rod between two press molds, wherein each press mold comprises a substantially semi-circular opening.

14. The method according to claim 13, further comprising spraying the rectangular rods or press molds or both with a releasing agent before pressing the rectangular rod between the two press molds.

15. The method according to claim 11, wherein the circular rods have a diameter of approximately about one inch or less and a length of approximately between about three inches to about five inches.

16. A chemical cleaning rod comprising:
a chemical cleaning compound comprising a chemical cleaning agent and a binding agent;
said chemical cleaning compound formed into a body having a width and a length; and
wherein the length is longer than the width.

17. The chemical cleaning rod according to claim 16, wherein the length is three or more times the width of the body.

18. The chemical cleaning rod according to claim 17, wherein the width is approximately about one inch or less.

19. The chemical cleaning rod according to claim 18, wherein the length is approximately between about three inches to about five inches.

20. The chemical cleaning rod according to claim 16, wherein the body has a substantially circular cross-section and wherein the width is equal to a diameter of the cross-section.
